(19) United States
(12) Patent Application Publication
(10) Pub. No.: US 2008/0205250 A1
(43) Pub. Date: Aug. 28, 2008

(54) Operating Optical Drive Using Parameters

(75) Inventor: Alexander Padiy, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/916,551

(22) PCT Filed: Jun. 1, 2006
(86) PCT No.: PCT/IB2006/051756

§ 371 Date: Dec. 5, 2007

(30) Foreign Application Priority Data
Jun. 9, 2005 (EP) 05105043.3

(51) Int. Cl. G11B 7/00

(52) U.S. Cl. 369/121

(57) ABSTRACT

The invention relates to operating an optical drive apparatus from parameters read from an associated record carrier. Data-aided adaptation loops are often used in modern communication and storage systems. To ensure fast and robust start-up by ensuring a stable starting point in an adaptation loop and a fast convergence of the adaptation loop, an information data field is provided on, and read from by the drive, an associated optical record carrier. The information data field comprising start-up parameters, the start-up parameters comprising information about recommended write parameters and information related to a resulting channel response for the case when the recommended write parameters are used. In a start-up situation of the optical drive apparatus, the channel response of the bit detector is computed based on the start-up parameters.

### FIELD OF THE INVENTION

The invention relates to operating an optical drive apparatus, and more particularly to operating an optical drive apparatus from parameters read from an associated record carrier.

### BACKGROUND OF THE INVENTION

Data-aided adaptation loops are often used in modem communication and storage systems. Moreover, in some cases no competitive non-data aided alternatives are available. This is the case, for example, in the ultra-high density Blu-ray optical disc system at high density with channel bit length below 60 nm.

Reliable data decisions have to be provided to the data-aided adaptation loops since in the case of the data decisions of poor quality the loops can become unstable, and this in turn may lead to the breakdown of the complete system. This issue is especially important during the system startup, when most of the adaptation loops are not settled yet. In order to resolve the above issue and ensure reliable startup of the adaptation loops, a preamble may be written on the storage media at fixed locations in between the user data, and the adaptation loops are then controlled using data patterns deduced read from the preamble. Such a scheme is employed, for example, in the majority of hard-disc drives. Then the adaptive channel response estimation/equalization can be performed using these known preamble patterns (see e.g. EP patent application 0 637 024).

On the other hand, the existing optical disc formats (e.g. CD, DVD or Blu-ray disc) does not employ preamble fields. One of the reasons for not including them in the format is the desire to be insensitive to media defects like scratches, the preamble-based systems may have severe problems in case of damaged preamble fields since they rely strongly on them.

Viterbi bit detectors (as being used in the most modem optical disc systems), for example, needs to know the channel model in order to make reliable bit decisions. During start-up the channel model for the given disc is unknown to the Viterbi detector, and it may fail if its default channel model (programmed in a factory) deviates too much from the actual channel response related to a given disc.

Therefore, in the case of optical disc systems, there is a need in the art to guarantee a reasonable performance of the bit detection circuit, especially during start-up of the system.

### SUMMARY OF THE INVENTION

The present invention seeks to provide an improved optical drive apparatus and associated carrier with improved means for ensuring improved drive start-up time and robustness. Preferably, the invention alleviates or mitigates one or more of the above or other disadvantages, singly or in any combination. Accordingly there is provided, in a first aspect, an optical drive apparatus and associated optical record carrier with optimised drive start-up, the apparatus comprising:

a radiation source for emitting a radiation beam so as to read and/or record optical effects on the optical record carrier,

a read unit for reading the recorded effects so as to provide a read signal,

a bit detector for providing modulation bits corresponding to the read signal values of a measured optical signal,
wherein the associated optical record carrier comprising an information data field comprising start-up parameters, the start-up parameters comprising information about recommended write parameters and information related to a resulting channel response for the case when the recommended write parameters are used, and
wherein in a start-up situation of the optical drive apparatus, the channel response of the bit detector is computed based on the start-up parameters.

The invention according to the first aspect is particularly but not exclusively advantageous since improved drive start-up time and robustness is ensured by basing the computed channel response of the bit detector on the start-up parameters. By basing the start-up channel response on a channel response of recommended write parameters, a stable starting point in an adaptation loop is guaranteed, providing a robust start-up procedure. Also a faster convergence of the adaptation loop is guaranteed, thereby providing faster start-up as well.

It is advantageous for the bit detection to have the recommended write-related parameters and the resulting write channel response on a blank rewritable or write-once disc provided by the manufacturer. If the information is supplied by the disc manufacturer, then the total (write+read) channel response can be computed by the drive during start-up, and ramping up the bit detector becomes a much easier task since the initial set of the reference levels can be computed using the approximately known drive read channel response. The same holds in the case of the ROM discs where it would be extremely beneficial for the robustness of the bit detection if the disc manufacturer supplies the write channel response used for mastering and replication of the disc in the manufacturing process.

The optional features as defined in dependent claim 2 are advantageous since by parameterisation of the resulting channel response in terms of average transition shifts of leading and/or trailing edges in a read signal obtained by a use of the recommended write parameters a very handy parameterization of the write channel response is put on the disc. The use of average transition shifts of leading and/or trailing edges in a read signal is especially advantageous, since such shifts are independent of the receiver. Information may therefore be put on the disc, which need not to take receiver equipment specifications into account.

The optional feature as defined in dependent claim 3 is advantageous since by providing the total channel response in the form of Viterbi reference levels, the channel response is provided in well-known format being used in most modem optical disc systems, and thereby a versatile and robust apparatus may be provided. The reference levels may depend on the type of the Viterbi detector used. Therefore, the total channel response data which are put on the disc may be specified for a certain reference readout system with well-specified optical spot and equalization parameters (similar to the way in which jitter values are specified for a certain reference setting in the CD/DVD/BD standards), and also the Viterbi type may be specified.

The optional feature as defined in dependent claim 4 is advantageous since by including information specifying the optical spot used for obtaining the channel response, a more complete set of parameters is provided, this facilitates an even faster and more robust start-up.

The optional features as defined in dependent claims 5-7 are advantageous since it may be ensured an appropriate write strategy is chosen in a recording situation, thereby ensuring a reliable record session. By optimising write parameters based on the average transition shifts and the start-up parameters, a direct connection between intended optical effects on the associated carrier and the real optical effects on the associated carrier is established already from the start of a record session, thereby ensuring optimal record conditions and consequently optimal data.

In a second aspect is provided, an optical record carrier comprising:

a substrate and at least one track being adapted for recording and/or reproducing optically readable effects positioned substantially along the track,

wherein the associated optical record carrier comprising an information data field comprising start-up parameters, the start-up parameters comprising information about recommended write parameters and information related to a resulting channel response for the case when the recommended write parameters are used.

The record carrier provided according to the second aspect may advantageously be used as the associated carrier of the first aspect.

The information data field may be placed as an information field comprised in the main channel or a side channel (e.g. a wobble channel). The information data field may be part of, or placed in the disc information zone which is always read out during the disc start-up. In this way robustly retrievable information fields similar to the way the write channel parameters are stored in CD, DVD and BD systems may be provided. The information data field may have a given data structure, e.g. comprising a header and a body. The header e.g. indicating the beginning of the information data field, and the body comprising the start-up parameters and possible also other parameters, additional disc information, etc.

According to a third aspect is provided, a method of setting start-up parameters of an optical drive apparatus according to the first aspect of the invention.

In a fourth aspect is provided, an integrated circuit (IC) for controlling an optical recording apparatus according to the first or third aspect of the invention.

In a fifth aspect is provided computer readable code for controlling an optical recording apparatus in accordance with the method of the third aspect of the invention.

The fourth and fifth aspects of the invention are particularly, but not exclusively, advantageous in that the present invention may be implemented by installing an IC or a computer program product enabling a computer system to perform the operations of the third aspect of the invention. Thus, it is contemplated that some known optical system may be changed to operate according to the present invention by installing an IC and/or a computer program product on a computer system controlling the optical drive apparatus system. Such a computer program product may be provided on any kind of computer readable medium, e.g. magnetically or optically based medium, or through a computer based network, e.g. the Internet.

The aspects of the present invention may each be combined with any of the other aspects. These and other aspects of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1 schematically illustrates an optical recording apparatus capable of reading and/or writing information from and/or to an associated optical record carrier,

FIG. 2 schematically illustrates a series of channel bits computed from an optical signal,

FIG. 3 shows matrix graphs for transitions from a mark runlength to a space runlength,

FIG. 4 schematically illustrates Viterbi bit detection in relation to an embodiment of the present invention, and

FIG. 5 illustrates start-up procedure steps in accordance with the present invention.

### DESCRIPTION OF PREFERRED EMBODIMENTS

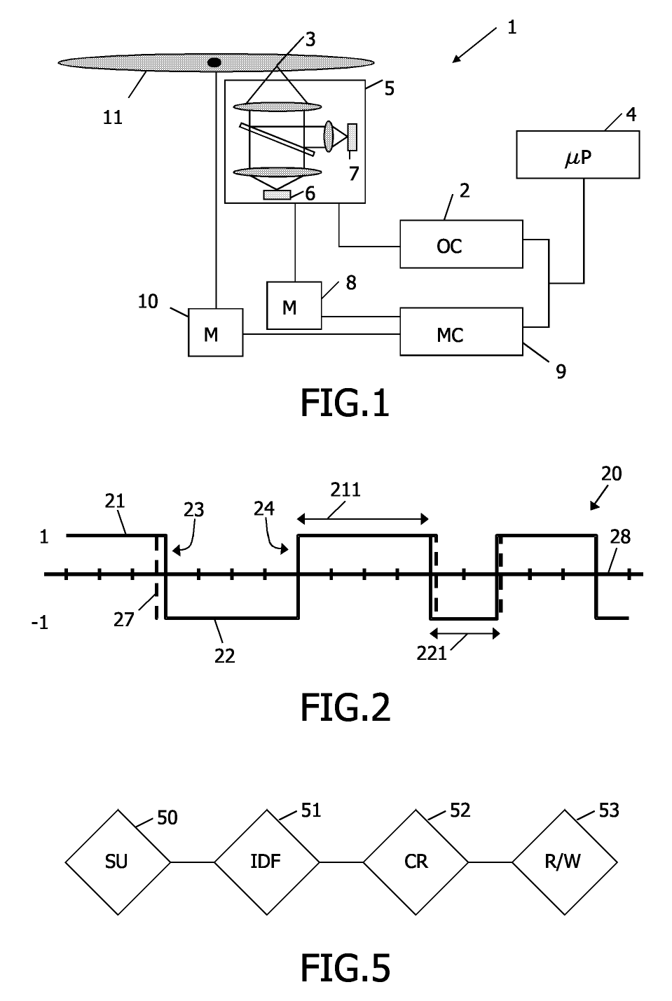

FIG. 1 schematically illustrates an optical drive apparatus 1 capable of reading and/or writing information from and/or to an associated optical record carrier.

A real optical drive apparatus comprises a large number of elements with various functions, only a few are illustrated here. Motor means 8,10 are present for rotating the disc 11 and controlling the motion of an optical pickup unit 5, so that an optical spot 3 can be focussed and positioned at a desired location on the disc. The optical pickup unit includes a laser 6, various optical elements and a photodetector 7 for reading the optical effects on the disc. The focussed laser light may in a recording mode be sufficiently intense so that optical effects may be provided to the optical disc. Alternatively, in a reading mode the laser power is insufficient to induce a physical change.

The control of the storage apparatus may be done by hardware implementation, such as illustrated by the motor control 9 and optics control 2. In addition, also microprocessor control means 4 is present. The microprocessor control means (e.g. integrated circuit (IC) means) may contain both hardwired processing means and software processing means, so that e.g. a user, such as by means of a high-level control software, may influence the operation of the apparatus. Examples of high-level control settings include control of the pulse shape in a write strategy of the emitted laser power in recording mode.

FIG. 2 illustrates a series of channel bits computed from an optical signal. The series of channel bits 20 comprising first sections 21 corresponding to light reflected from first regions with first widths 211, being spaces or high reflectivity regions, and second sections 22 corresponding to light reflected from second regions with second widths 221, being marks or low intensity regions. The transitions from the first to the second regions are labelled leading edges 23, and transitions from the second regions to the first regions are labelled trailing edges 24.

On a real disc, the transitions from a high reflectivity (space) to low reflectivity (mark) are not always on the right position. Some are too much to the left (early in time=negative per definition) and some too much to the right (too late=positive). This is illustrated by the dotted lines 27 which indicate the measured edge position. In the figure a time axis 28 is illustrated as a horizontal axis, the time axis being discretised with so-called 1T (=1 channel bit) resolution. For an ideal signal, the transitions should lie on a 1T mark.

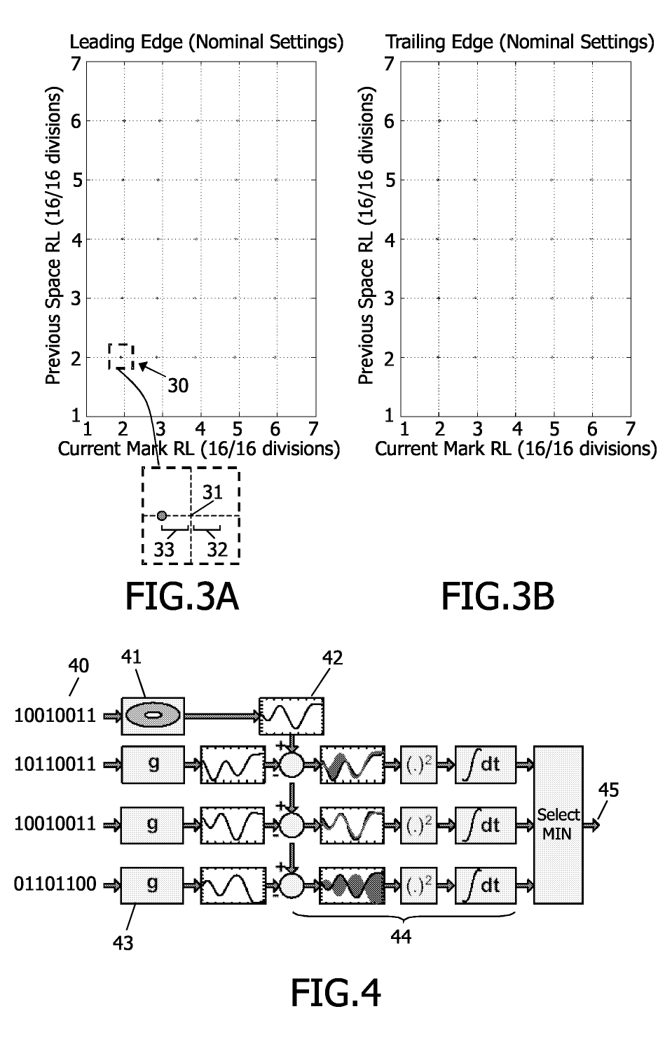

The average transition shifts of the various combinations of marks and previous/next adjacent spaces may be measured on an optical disc. An example of a matrix representation of the transition shifts is given in FIG. 3 for measurements on a write-once disc with a nominal write strategy.

In FIG. 3, all leading (FIG. 3A) and trailing (FIG. 3B) edge shifts are shown for a given section of a disc, and for every combination of current mark (x-axis) and prev/next space (y-axis) a dot 30 is drawn. The dot is found exactly on the cross-point 31 when there is no shift, and on the right 32 of it when there is a positive shift (too late) and on the left 33 of this cross-point when there is a negative shift (too early).

A bit detector is present for extracting the bit sequence as present on the disc. The extraction is a complicated process requiring a number of steps, such as error correction steps, signal processing, channel encoding/decoding etc. In this process, the channel response needs to be established. FIG. 4 schematically illustrates Viterbi bit detection in relation to an embodiment of the present invention.

In FIG. 4, the bit sequence 10010011 (reference numeral 40) is present on an optical record carrier 41. However, due to convolution from the radiation beam the read signal is a modulated signal representing the bit sequence 42. On high-density record carriers, the read signal is not directly extractable, e.g. due to inter-symbol phenomena, shape of marks, etc. In the Viterbi bit detection scheme several bit sequences are evaluated 44, and the most likely bit sequence 45 is taken as the sequence as present on the carrier. In order to extract the bit sequence, the channel model response g 43 is used to model read signals of the bit sequences.

FIG. 5 illustrates steps to be conducted in order to in order to facilitate proper operation in the start-up procedure in accordance with the present invention.

In a start-up procedure SU 50, the information data field of the associated disc is first consulted IDF 51. The information data field on the associated optical record carrier may be part of, or placed in the disc information zone which is always read out during the disc start-up. The information data field comprising recommended write parameters and information related to a resulting channel response for the case when the recommended write parameters are used, so that the optical drive apparatus may compute or construct the channel response of the bit detector based on the start-up parameters 52. The further operation, such as normal read/write (R/W) of the optical drive 53 may then continue. The information of the data field may be used only during the start-up, or at a later stage if appropriate. The recommended write parameters comprised in the information data field, may be such parameters as: the nominal, the maximum and the minimum recording velocities to be used with the parameters as defined, the maximum read power to be used at various disc velocities, various parameters used in connection with establishing the write strategy, pulse durations, etc.

The resulting channel response may be parameterized in terms of average transition shifts of leading and/or trailing edges in a read signal obtained by use of the recommended write parameters. Alternatively, may the resulting channel response is the total channel response in the form of Viterbi reference levels.

Depending upon the functionality of the optical drive apparatus more or less information may be provided in the information data field or alternatively, the optical drive apparatus may be adapted to extract more or less information from the information data field. The information data field may include information specifying the optical spot used for obtaining the channel response. It may include information specifying an initial write strategy for use in a recording situation, etc.

In one embodiment, the information data field comprise edge shifts of leading and/or trailing edges, as illustrated in matrix format in FIG. 3. The edge shifts are especially advantageous, since in addition to using them for extracting an initial channel response, this information may also be used for other purposed through out the reading/recording session. As an example, average transition shifts of optical effects provided to the associated carrier in a first part of the recording process may be evaluated by subsequent reading the data and optimise the write strategy based on the average transition shifts and the start-up parameters, the optimised write strategy being used in a second part of the recording process. Since the edge shifts are known for an situation recommended by the disc manufacturer as provided in the information data field, the recording of data to the associated carrier, may continuously be evaluated up against the recommended data, and adjusted in accordance with rules, such as empiric rules dictating how to adjust the write strategy in order to minimize a difference between recorded optical effects and reference optical effects. The reference optical effects being represented by the recommended edge shifts, provided in the information data field. The rules may e.g. include that a write pulse may be optimised in accordance with an average transition shifts of a specific type of leading and/or trailing edge.

Although the present invention has been described in connection with preferred embodiments, it is not intended to be limited to the specific form set forth herein. Rather, the scope of the present invention is limited only by the accompanying claims.

In this section, certain specific details of the disclosed embodiment are set forth for purposes of explanation rather than limitation, so as to provide a clear and thorough understanding of the present invention. However, it should be understood readily by those skilled in this art, that the present invention may be practised in other embodiments which do not conform exactly to the details set forth herein, without departing significantly from the spirit and scope of this disclosure. Further, in this context, and for the purposes of brevity and clarity, detailed descriptions of well-known apparatus, circuits and methodology have been omitted so as to avoid unnecessary detail and possible confusion.

Reference signs are included in the claims, however the inclusion of the reference signs is only for clarity reasons and should not be construed as limiting the scope of the claims.

1. Optical drive apparatus (1) and associated optical record carrier (11) with optimised drive start-up, the apparatus comprising:
a radiation source (6) for emitting a radiation beam so as to read and/or record optical effects on the optical record carrier,
a read unit (7) for reading the recorded effects so as to provide a read signal,
a bit detector for providing modulation bits corresponding to the read signal values of a measured optical signal,
wherein the associated optical record carrier comprising an information data field (51) comprising start-up parameters, the start-up parameters comprising information about recommended write parameters and information related to a resulting channel response for the case when the recommended write parameters are used, and
wherein in a start-up situation of the optical drive apparatus, the channel response (52) of the bit detector is computed based on the start-up parameters.

2. Apparatus according to claim 1, wherein the resulting channel response (52) is parameterized in terms of average transition shifts of leading and/or trailing edges in a read signal (30) obtained by use of the recommended write parameters.

3. Apparatus according to claim 1, wherein resulting channel response is the total channel response in the form of Viterbi reference levels.

4. Apparatus according to claim 1, wherein in addition to the resulting channel response the start-up parameters also include the information specifying the optical spot used for obtaining the channel response.

5. Apparatus according to claim 1, wherein in a recording situation where the radiation source emitting a radiation beam so as to record optical effects on the recordable medium, the radiation beam being emitted in accordance with a write strategy including one or more write parameters, and wherein the initial write strategy is determined based on the start-up parameters.

6. Apparatus according to claim 5, further comprising processing means for evaluating average transition shifts of optical effects provided to the associated carrier in a first part of the recording process and read subsequently and optimising at least one of the one or more write parameters in the write strategy based on the average transition shifts and the start-up parameters, the optimised write strategy being used in a second part of the recording process.

7. Apparatus according to claim 6, wherein one or more write parameters in the write pulse is optimised according to an average transition shifts of a specific type of leading and/or trailing edge.

8. An optical record carrier (11) comprising:
a substrate and at least one track being adapted for recording and/or reproducing optically readable effects positioned substantially along the track,
wherein the associated optical record carrier comprising an information data field (51) comprising start-up parameters, the start-up parameters comprising information about recommended write parameters and information related to a resulting channel response for the case when the recommended write parameters are used (52).

9. Method of setting start-up parameters of an optical drive apparatus (1), the apparatus comprising:
a radiation source (6) for emitting a radiation beam so as to read and/or record optical effects on the optical record carrier,
a read unit (7) for reading the recorded effects so as to provide a read signal,
a bit detector for providing modulation bits corresponding to the read signal values of a measured optical signal,
the method comprising the steps of:
reading from an associated optical record carrier start-up parameters comprised in an information data field (51), the start-up parameters comprising information about recommended write parameters and information related to a resulting channel response for the case when the recommended write parameters are used (52), and
setting parameters of a start-up situation of the optical drive apparatus in accordance with the start-up parameters.

10. Integrated circuit (IC) for controlling an optical recording apparatus, the IC being adapted to operate an optical drive by setting one or more operation parameters in accordance with start-up parameters read from an information data field comprised on an associated optical record carrier.

11. Computer readable code for controlling an optical recording apparatus in accordance with the method of claim 9.
